(19) United States
(12) Patent Application Publication
(10) Pub. No.: US 2013/0221058 A1
(43) Pub. Date: Aug. 29, 2013

(54) PIN ANCHOR DRIVER

(71) Applicant: Milwaukee Electric Tool Corporation, (US)

(72) Inventors: Roger D. Neitzell, Palmyra, WI (US); Ryan Malloy, Milwaukee, WI (US)

(73) Assignee: MILWAUKEE ELECTRIC TOOL CORPORATION, Brookfield, WI (US)

(21) Appl. No.: 13/771,394

(22) Filed: Feb. 20, 2013

Related U.S. Application Data
(60) Provisional application No. 61/603,637, filed on Feb. 27, 2012.

(51) Int. Cl. B25D 17/02

(52) U.S. Cl. CPC B25D 17/02
USPC 227/147

(57) ABSTRACT

A pin anchor driver for use with a rotary hammer includes a main shaft having a bore in which a drill bit of the rotary hammer is at least partially receivable, a driver head coupled to the main shaft, and a magnet positioned between the main shaft and the driver head.

### CROSS-REFERENCE TO RELATED APPLICATIONS

This application claims priority to co-pending U.S. Provisional Patent Application No. 61/603,637 filed on Feb. 27, 2012, the entire content of which is incorporated herein by reference.

### FIELD OF THE INVENTION

The present invention relates to pin anchors, and more particularly to tools used for driving pin anchors into a concrete or masonry structure.

### BACKGROUND OF THE INVENTION

Multiple different tools are typically required for installing pin anchors in concrete or masonry structures. For example, a drill may be first used to form a hole in the concrete or masonry structure. Then, the pin anchor is inserted into the hole and a hammer may be utilized to pound the pin anchor into the masonry material.

### SUMMARY OF THE INVENTION

The invention provides, in one aspect, a pin anchor driver for use with a rotary hammer. The pin anchor driver includes a main shaft having a bore in which a drill bit of the rotary hammer is at least partially receivable, a driver head coupled to the main shaft, and a magnet positioned between the main shaft and the driver head.

The invention provides, in another aspect, a tool for driving pin anchors. The tool includes a main shaft, a non-ferrous driver head coupled to the main shaft, and a magnet positioned between the main shaft and the driver head. The tool also includes a sleeve slidably disposed on the main shaft between extended and retracted positions for supporting a pin anchor therein.

Other features and aspects of the invention will become apparent by consideration of the following detailed description and accompanying drawings.

### BRIEF DESCRIPTION OF THE DRAWINGS

FIG. 1 is a front perspective view of a pin anchor driver according to one embodiment of the invention.

FIG. 2 is an exploded, front perspective view of the pin anchor driver of FIG. 1.

FIG. 3 is a cross-sectional view of the pin anchor driver of FIG. 1, illustrating a sleeve of the pin anchor driver in a retracted position.

FIG. 4 is an enlarged, cross-sectional view of the pin anchor driver of FIG. 1, illustrating the sleeve in an extended position.

FIG. 5 is an enlarged, cross-sectional view of the pin anchor driver of FIG. 1, illustrating the sleeve in an extended position and a pin anchor received within the sleeve.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

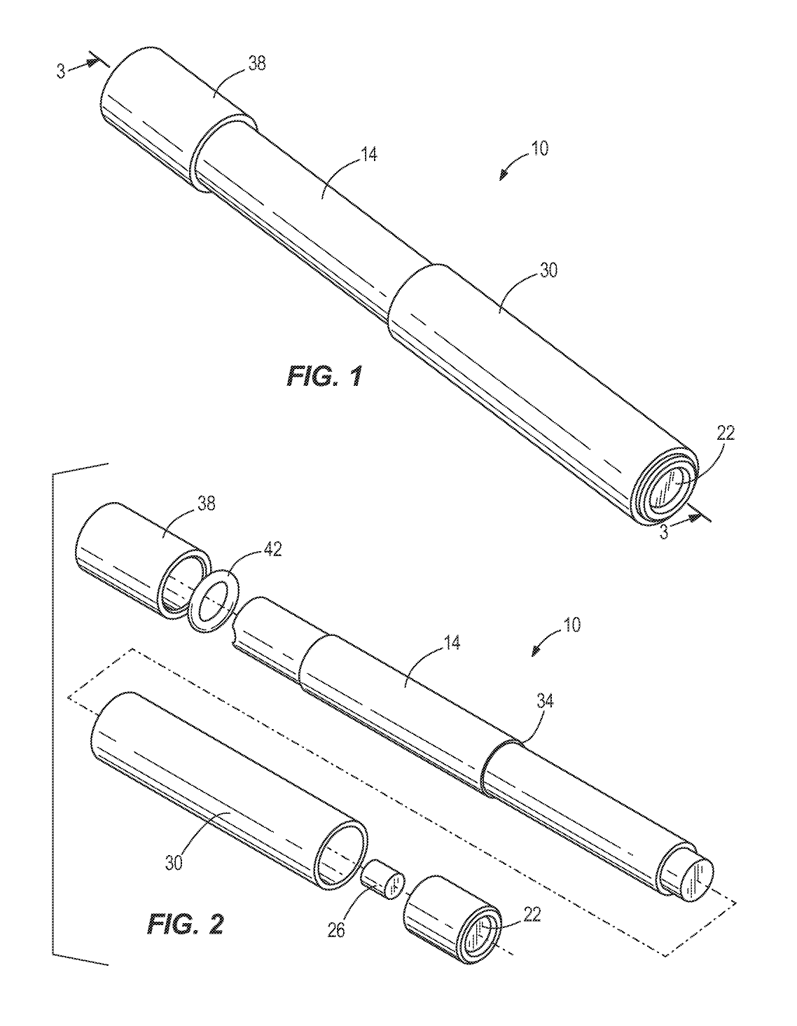

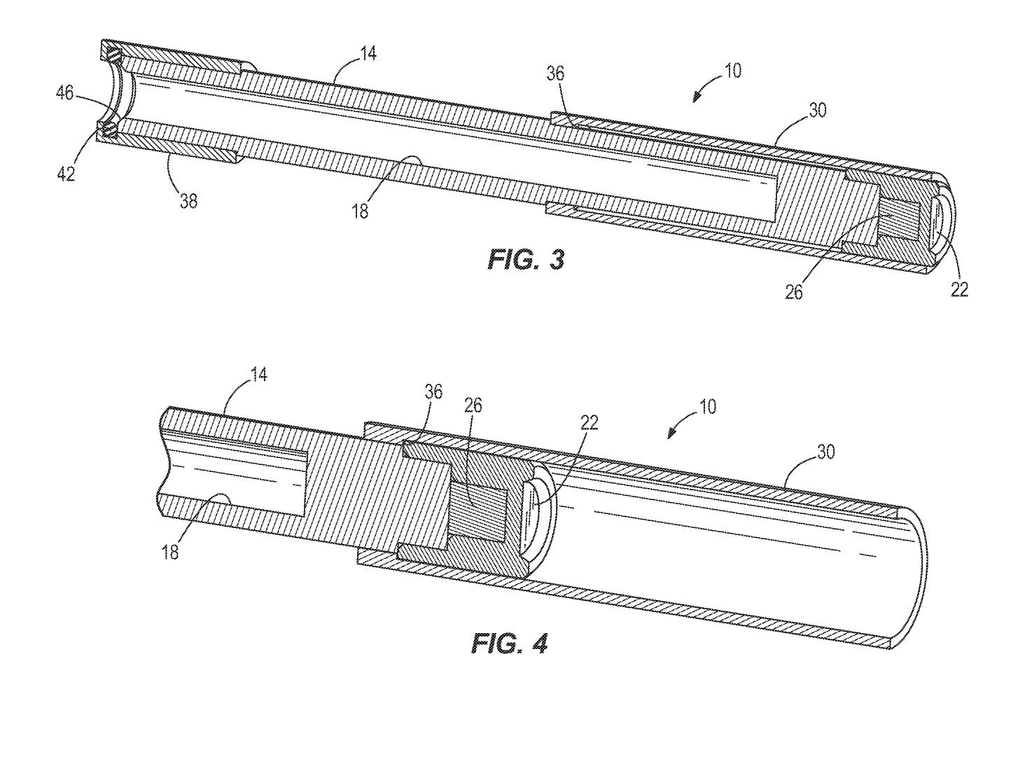

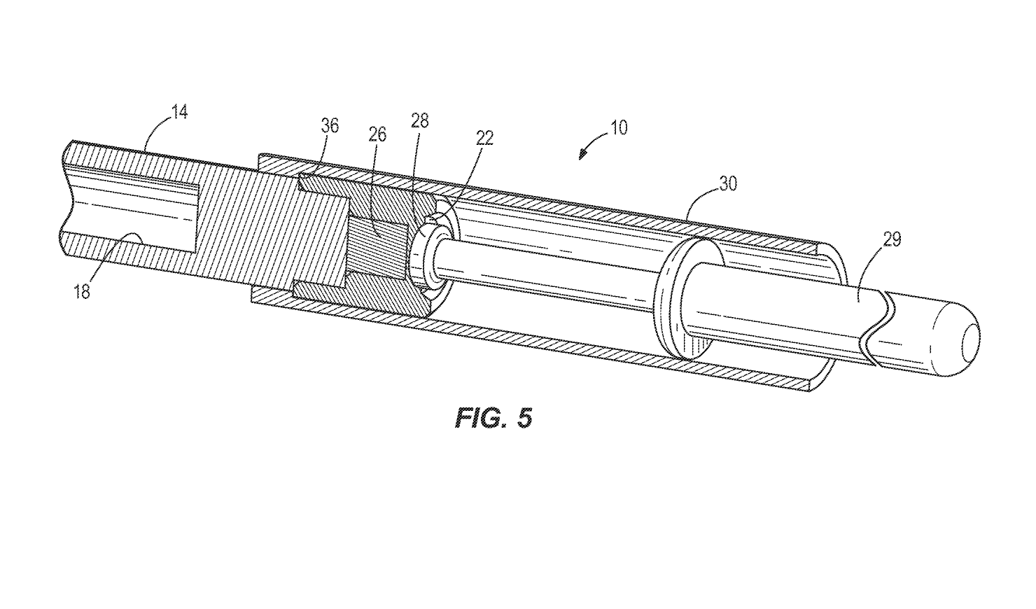

FIG. 1 illustrates a pin anchor driver 10 that is used with a rotary hammer (not shown) for driving pin anchors into concrete or other masonry surfaces. Such pin anchors are used to attach brackets and like structure to concrete surfaces. The pin anchor driver 10 includes a main shaft 14 having a longitudinal blind bore 18, a non-magnetic (e.g., stainless steel) driver head 22 press-fit to the main shaft 14, and a magnet 26 positioned between the main shaft 14 and the driver head 22 (FIGS. 2 and 3). As such, the main shaft 14, the driver head 22, and the magnet 26 are coaxial. The driver head 22 includes a recess in which a head 28 of a pin anchor 29 is at least partially received (FIG. 5).

The pin anchor driver 10 also includes a sleeve 30 slidably disposed on the main shaft 14 between an extended position (FIGS. 4 and 5) in which the pin anchor 29 may be at least partially received within the sleeve 30, and a retracted position (FIGS. 1 and 3). In the extended position (FIGS. 4 and 5), the sleeve 30 axially overlaps the pin anchor 29 when the head 28 of the pin anchor 29 is positioned adjacent the driver head 22. A magnetic force exerted by the magnet 26 on the pin head 28 maintains the pin head 28 adjacent and in contact with the driver head 22. Movement of the sleeve 30 is confined between the extended and retracted positions by the driver head 22 and a shoulder 34 formed around the exterior of the main shaft 14 (FIG. 2), respectively. Alternatively, the shoulder 34 may be replaced by a retaining ring on the main shaft 14. As shown in FIG. 4, the outer diameter of the driver head 22 is larger than the inner diameter of an internal shoulder 36 of the rear end of the sleeve 30 (i.e., the end opposite that which engages the workpiece). As such, interference with the driver head 22 prevents the sleeve 30 from being removed from the main shaft 14.

The pin anchor driver 10 further includes a retaining collar 38 press-fit to the outer periphery of the main shaft 14 (FIGS. 1-3). An O-ring 42 is received within an inner circumferential groove in the retaining collar 38.

To use the pin anchor driver 10, a drill bit of the rotary hammer (not shown) is inserted in the blind bore 18 of the main shaft 14. A shoulder on the drill bit engages an internal shoulder 46 (FIG. 3) of the main shaft 14 to limit the extent to which the drill bit may be inserted into the bore 18. The O-ring 42 frictionally engages the drill bit for holding the pin anchor driver 10 to the drill bit and the rotary hammer. The sleeve 30 is moved to the extended position, and a pin anchor 29 is positioned within the sleeve 30 with the pin head 28 located adjacent and in contact with the driver head 22. The pin head 28 is held in contact with the driver head 22 by the magnet 26. A distal end of the sleeve 30 is then positioned against a workpiece (e.g., a bracket), with the pin anchor 29 aligned with an aperture in the workpiece and a bore in the underlying concrete or masonry surface. When the rotary hammer is activated in impact-only mode (i.e., without rotation), axial impacts are transferred from the drill bit to the driver head 22 via the main shaft 14 for incrementally driving the pin anchor 29 into the workpiece and the underlying concrete or masonry surface. As the pin anchor 29 is incrementally driven in this manner, the sleeve 30 moves from the extended position to the retracted position.

Various features of the invention are set forth in the following claims.

What is claimed is:

1. A pin anchor driver for use with a rotary hammer, the pin anchor driver comprising:
a main shaft including a bore in which a drill bit of the rotary hammer is at least partially receivable;
a driver head coupled to the main shaft; and
a magnet positioned between the main shaft and the driver head.

2. The pin anchor driver of claim 1, further comprising a sleeve slidably disposed on the main shaft between extended and retracted positions for supporting a pin anchor therein.

3. The pin anchor driver of claim 2, wherein the sleeve axially overlaps the pin anchor when in the extended position.

4. The pin anchor driver of claim 3, wherein a head of the pin anchor is positioned adjacent the driver head, and wherein a magnetic force exerted by the magnet on the head of the pin anchor maintains the head of the pin anchor adjacent the driver head.

5. The pin anchor driver of claim 2, wherein the sleeve is engageable with the driver head when in the extended position.

6. The pin anchor driver of claim 5, wherein the sleeve includes an internal shoulder engageable with the driver head in the extended position.

7. The pin anchor driver of claim 2, wherein the main shaft includes a shoulder, and wherein the sleeve is engageable with the shoulder when in the retracted position.

8. The pin anchor driver of claim 1, further comprising:
a retaining collar coupled to the main shaft; and
an O-ring positioned within the retaining collar and engageable with the drill bit for securing the pin anchor driver to the drill bit.

9. The pin anchor drive of claim 8, wherein the retaining collar is press-fit to the main shaft.

10. The pin anchor drive of claim 1, wherein the main shaft includes an internal shoulder for limiting the extent to which the drill bit is received within the main shaft.

11. The pin anchor driver of claim 1, wherein the main shaft, the driver head, and the magnet are coaxial.

12. The pin anchor driver of claim 1, wherein the driver head includes a recess in which a head of a pin anchor is at least partially received.

13. The pin anchor driver of claim 1, wherein the driver head is non-magnetic.

14. The pin anchor driver of claim 1, wherein the driver head includes a bore in which the magnet is positioned.

15. The pin anchor driver of claim 1, wherein the driver head is press fit to the main shaft.
